(19) United States
(12) Patent Application Publication
(10) Pub. No.: US 2003/0177080 A1
(43) Pub. Date: Sep. 18, 2003

(54) Parallel investment evaluation system

(76) Inventor: Stephen P. Laurie, Shropshire (GB)

Correspondence Address: ROBERT H FRANTZ, P O BOX 23324, OKLAHOMA CITY, OK, 73123

(21) Appl. No.: 10/098,692

(22) Filed: Mar. 15, 2002

(51) Int. Cl. G06F 17/60

(52) U.S. Cl. 705/36

(57) ABSTRACT

A system and method which determines the likely return on investment from a combination of investment projects, which may differ markedly from the sum of the returns of each investment considered in isolation, thereby allowing an organization to select the combination which offers the greatest return. A set of all combinations of investments is formed, then reduced to a set of all possible combinations according to a set of constraints such as project exclusivity. This set is further reduced by applying rules specifying the maximum value added. The reduced set of combinations is analyzed to find the investment combination yielding the maximum value added combination of investment projects.

### TECHNICAL FIELD OF THE INVENTION

This invention relates to the fields of assisting organizations to evaluate investment decisions.

### CROSS-REFERENCE TO RELATED APPLICATIONS

Not applicable.

### FEDERALLY SPONSORED RESEARCH AND DEVELOPMENT STATEMENT

This invention was not developed in conjunction with any Federally sponsored contract.

### MICROFICHE APPENDIX

Not applicable.

### BACKGROUND OF THE INVENTION

Companies have traditionally evaluated opportunities for investment in isolation to each other. Typical methods include as an early step projecting future cash flows expected to yield from the investment. The value of these cash flows can then be calculated.

One method is to calculate a Net Present Value (“NPV”) by discounting at a suitable risk rate of interest. If the Net Present Value is positive, then the investment adds value to a portfolio. If there is a range of attractive investment opportunities but not all of which can be made at the same time, then those investments with the highest Net Present Value can be selected.

An alternative method is to calculate the Internal Rate of Return, which is the rate of interest which gives a zero Net Present Value. This Internal Rate of Return can then be compared to a “hurdle rate”. If the rate of return is greater than the hurdle rate, then the project goes ahead.

These methods all assume that investment projects can be considered on a stand-alone basis. In other words, the return rates on investments are implicitly assumed to be linear so that each one can be evaluated in isolation of the others.

However, in many industries, the return on internal investment projects is frequently non-linear. The return from several projects carried out together will not in general be equal to the sum of the return from each project carried out in isolation. This phenomenon has important implications for the way in which companies decide in which projects to invest. A company must somehow evaluate all combinations of investment opportunities together—not in isolation.

The non-linearity referred to here is not generated by inter-dependencies within investment projects. For example, if a company is developing a new product there are many separate investments that need to be made. These may cover areas such as product design, manufacturing or production investments for a physical product, staff training, updating computer systems, developing brochures, manuals and marketing materials. All these investments have to be made together for the product introduction to be effective and each investment may be valueless without the other investments. Traditional methods recognize such dependencies and would evaluate all the separate investments required in the product development project as one whole.

However, the point that is missed from traditional methods is that the return from investment projects is frequently non-linear even when there are no dependencies. This occurs because the cost of many types of investment is not proportional to the volume of the product produced. One of the best and most pervasive examples is computer software. The cost of developing software is almost independent of value. For example, if a financial services company is developing software to administer a new financial services product, then the development cost would be the same if one or one million units of the product are produced and sold. In a modern economy, there are many other costs which are independent of volume.

To see how such volume-independent costs give rise to non-linearity, it is necessary to take a further step. Investments are made by companies to enable products or services to be produced and sold to the ultimate consumer. Companies will price their products so as to maximize their profit from those products. The text book rule is that the optimal price will depend on the function relating costs to volumes produced and upon the function relating demand for the product against price. One way of representing this is to say that the optimal price is equal to:

Optimal price=Marginal costs·(1+(1/(Price sensitivity−1))).

In this formula, the marginal cost is the cost of producing one extra unit of production, typically excluding any overhead or fixed costs. The price sensitivity is the ratio of the percentage change in demand for a product, divided by the percentage change in price for small changes in the price.

For example, suppose it costs $100 of marginal expenses to manufacture and distribute a product, and that the price sensitivity is 4. Then the optimal price is $100+($100/(4−1))=$133. At this price, the contribution to overhead and profit will be maximized. (It should be noted that the optimal price does not depend upon the level of overheads of the firm).

When considering an investment opportunity, a company should take into account the change in the product price. The following numerical example should illustrate the process. Suppose a company makes a product at a marginal cost of $10 per unit. If the price sensitivity of the market is 4, then the optimal price will be $13.33. Suppose that at this price it makes 100,000 sales per annum. Now, suppose that the company is considering an investment Project “A” requiring $1M, which would reduce the marginal cost of a unit of a product by $1.77. Further suppose that the investment has a lifetime of 5 years after which the investment will have zero value. At the existing output of 100,000 units, the investment in Project “A” would yield savings of $177,000 per annum for five years. The return on capital is negative, as the company would not recoup its initial investment, and on this basis the company would decide to not make the investment.

However, in this example, the company should consider the situation after re-pricing the product. In this case, the marginal cost is lowered to $8.23 and the new optimal price is $10.98. If the price sensitivity is 4, then this reduction in price will cause a more than doubling of volumes to 218,000. The incremental improvement in annual cash flows generated by the investment rises to $264,000 allowing for the new price, volumes and costs. The internal rate of return on the investment is now 10%. The reason for the improvement is that at the higher volume, the reduction in marginal costs is worth more compared to the fixed initial investment.

When more than one investment is being considered, the situation can be much more complex to understand and analyze. For example, suppose there is a second investment Project “B”, which is independent of the first Project “A”, and which could also reduce marginal costs by $1.77 per unit at a capital investment cost of $1M. Like the investment in Project “A”, the investment in Project “B” would yield a negative return if the company did not re-price the product, and it would yield a 10% return if the company did re-price the product. Further suppose that the company's hurdle rate of return for investment projects were 12%. Then both investments A and B, as considered in isolation, would be rejected as failing to meet the hurdle rate target.

However, although neither investment meets the required return in isolation, if made together, their combined effect would greatly exceed the return. If both A and B were made, then marginal costs would be reduced to $6.46. The optimal price would now be $8.62, and this fall in price would produce an increase in sales volume to 572,000 units per year. At the new price and volume, the two investments together would generate an annual return of $900,000 for the combined initial investment of $2,000,000. The internal rate of return is now 35%, which is greatly in excess of the hurdle rate of 12%.

This example shows the danger of considering investment decisions in isolation, yet this is how most investment decisions are currently made. Therefore, there is a demonstrated need to consider all possible investment options “in parallel”, rather than in isolation. This is true even if all the investments cannot be made at once. For example, if it were not possible to execute both Project “A” and Project “B” in the same year due to financial or management constraints, the investment decision regarding Project “A” should still be analyzed assuming that Project “B” is undertaken in a subsequent year.

However, there are a number of problems to be overcome to enable companies to evaluate investments in a parallel manner. First, it should be emphasized that the various investment decisions to be considered will normally be quite discrete and will often be owned by separate functions in the company. For example, manufacturing, human resources, marketing, customer servicing, and information technology departments may all have projects mainly in their own areas that could affect unit costs. Individuals in such separate departments will not see the “whole picture” and will not spot that, for example, apparently separate investments in manufacturing technique and sales training may be linked through the financial dynamics of the product.

A further complication is that many projects will impact more than one product. For example, suppose human resources are considering a new staff training program which, for an initial outlay, will result in more productive staff and hence lower unit costs. These cost savings will be spread over all the products which the company makes.

Perhaps, the most fundamental problem of all is that the different elements of the evaluation process will usually be owned by different functional ‘silos.’ Normally, identifying investment projects would be the responsibility of the various operating departments, while pricing and forecasting demand will be the responsibility of marketing department, and the financial evaluation of the investment opportunity will be the responsibility of a finance department. It is impossible to optimize the evaluation process if each function works on their own piece of the puzzle separately.

Therefore, there exists a need in the art for a system and method which companies can use to evaluate investment decisions in parallel. Such a system must examine a large number of combinations of different investment possibilities. It must allow for collaborative working between different departments and functions, and even between people external to the organization, such as suppliers and consultants.

Furthermore, there is also a need for a system and method which enables companies to search out promising areas for investment. Such areas will be those in which an investment will produce positive non-linear returns when combined with other existing or possible investments. Such positive non-linear returns can transform an otherwise mediocre investment proposition into a high return proposition. However, if considered strictly in isolation, the mediocre investment opportunity may never have been actively pursued by the department or function which would own it because it does not look attractive. As such, the new system and method should be able to identify and quantify these otherwise missed opportunities.

### SUMMARY OF THE INVENTION

The Parallel Investment Evaluation system and method allows organizations evaluate investment decisions unlike traditional processes of evaluating investment projects which evaluate each investment opportunity or project in isolation of the other opportunities or projects. Such well-known “serial” methods are based upon the assumption that the return from a given investment project does not depend on whether other investment projects go ahead or not.

However, the returns from even apparently unrelated investment options projects are often linked through the financial and market dynamics of the products and services which are being produced or supplied. This means that almost all investment decisions made by a business unit will exhibit strongly non-linear returns. The return from a combination of investment projects may differ markedly from the sum of the return of each investment in isolation. The present invention provides a means of enabling an organization to evaluate the returns from such combinations inclusive of their synergistic characteristics, thereby allowing the organization to select the combination which offers the greatest return.

The present invention will, therefore, help companies make better investment decisions, increase revenue and earn greater returns on their investments. It will also enable companies to identify additional areas for profitable investments which will result in greater efficiency and improve their competitive advantage. Further, the present invention benefits customers by boosting investment in areas which will drive down unit costs and hence prices. In a broader sense, the present invention may help the economy as a whole by encouraging greater investment efficiency and output.

The invention first forms a set of all combinations of investments that may be, and then reduces the set of all possible combinations according to a set of constraints such as project exclusivity. The set of all possible projects is further reduced by a rule specifying the maximum value added, and then this reduced set of combinations is analyzed to find the combination yielding the maximum value added combination of investment projects.

### BRIEF DESCRIPTION OF THE DRAWINGS

The figures presented herein when taken in conjunction with the disclosure form a complete description of the invention.

FIG. 1 presents an overview of the logical process of the invention in the case in which all combinations of possible investments are examined.

FIG. 2 provides more details of the logical process for calculating NPV for an investment combination.

FIG. 3 provides more detail of the embodiment involving the Increasing mutual Returns Rule.

FIG. 4 shows the logical process for reducing an investment combination to the optimal combination.

FIG. 5 shows the structure of the product category database according to the preferred embodiment.

FIG. 6 shows the structure of the investment projects database according to the preferred embodiment.

FIG. 7 shows the well-known arrangement of networked computers and details of common computing platforms.

### DETAILED DESCRIPTION OF THE INVENTION

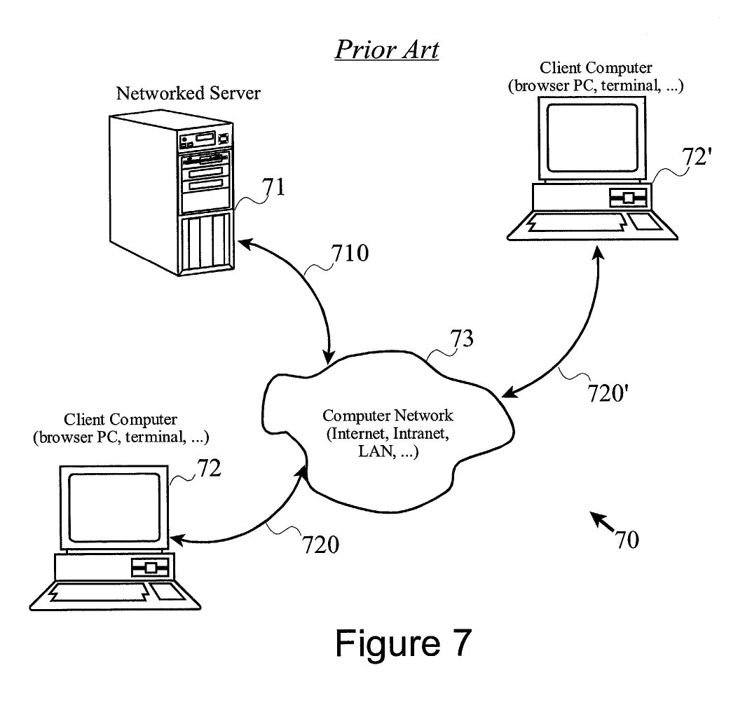

The Parallel Investment Evaluation (“PIE”) is preferably realized as an investment analysis software package for execution on a computer platform (72, 72′, 71) as shown in FIG. 7, such as an IBM-compatible personal computer, Apple computer, or larger, enterprise-grade “main frame” computer. These computer platforms are well-known in the art. Each typically comprises a processor for executing software, processor memory such as random-access memory (RAM), persistent data storage such as one or more hard disk drives, an operating system, and one or more application programs, applets and/or servlets. In the case of a networked server (71), it may be provided with proprietary client server software for communicating with a client computer, or it may be provided with a “standard” or “open” communications capability such as hyper text transfer protocol (HTTP) server software. In the case of the networked client computers (72, 72′), these may be the well-known web browser computers such as personal computers with Netscape's Navigator web browser, so-called “dumb terminals”, or any of a variety of web-enabled devices such as personal digital assistants (PDAs) or wireless telephones.

According to preferred embodiment, the method of the present invention is implemented on a network of such computers. For example, such a network (73) might be a local area network (LAN), the well-known Internet, an Intranet, a virtual network or some other computer networking means. Access (710, 720, and 720′) to this network may be made through any of several well-known access means, such as through a dial-up modem using a telephone line, a LAN, wireless access protocol, a digital subscriber line (DSL) or cable modem. The invention may also be realized on a single computer with multiple terminals, or on a stand-alone computer.

As such, the remainder of this disclosure is given relative to the methods and processes to be implemented in a software application program using a suitable programming language and methodology. According to the preferred embodiment, the software is realized using Object Oriented Programming methodologies (OOP), in Sun Microsystem's Java™ programming language, but it will be readily recognized by those skilled in the art that alternate methodologies and languages may be adopted without departing from the spirit and scope of the present invention.

For better understanding of the present invention, the following are definitions used throughout this disclosure:

A “product” is any type of good, commodity or service, including financial services and products, which is sold on a commercial basis.

An “investment” is defined widely to include any spending which is intended to produce future benefits for the organization. It is intended not just to cover capital purchases, but also such items as systems development, product development, marketing and advertising campaigns, training programs, and process enhancement.

The “demand” or “volume of demand” of a product is the amount of the product that can be sold in a period at given price. The volume of demand may be measured by the number of units sold, or by some other measure such as a value of sales index.

The “demand model” is a means by which the demand for a product is calculated from the price of the product.

The “cost model” is a means by which the cost of producing a product is calculated based upon the demand for that product.

The “net present value” (NPV) is an amount representing the discounted value of revenue minus costs.

The invention keeps track of a number of product categories or products. Such a product or service may be a currently offered product or service, or it may be a planned or potential product or service.

The “projection period” is fixed in each analysis case, and is typically an interval of around three to ten years. The projection period starts at the projection base time, and is divided into convenient time intervals such as months, quarters or years.

Some investments may have a lifetime less than the projection period because the investment or the effect of the investment wears out before then. In such cases, the investment will not have any effect on costs after the end of its lifetime. In some cases, it may be more realistic to define the investment in such a way as if it were automatically renewed at the end of its lifetime. In such a case, the benefits of the investment would continue, but there would be an additional cost at the time of renewal representing the required reinvestment amount.

If an investment lasts longer than the projection time period, then it is necessary to capture the benefits that arise after the end of the projection time period. This is done by calculation of a “terminal value” for the investment. The terminal value is defined as a negative cost accruing to the organization at the end of the projection period. This negative cost reflects the fact that the investment does not need to be replaced at the end of the period. This enables the organization to reduce its costs in subsequent periods while still retaining some or all of the value of the investment.

The amount of the credit is determined by the system operator in each case. For example, it might be set to an assumed “second hand” market value, a depreciated value of equipment, or an assumed amortized value of development expenditure.

For each product category in each time interval, a cost model is specified. The cost model is a means by which the cost for a product line is calculated from the volume of demand for the product. In the preferred embodiment, the means of calculating the cost is the simple formula:

Cost=Product Fixed Costs+((Product Marginal Costs)·(Sales Volume))

In this formula, Product Fixed Costs are the costs which are required to produce and market the product which are not dependent upon the amount of the product produced. Product Marginal Costs are those elements of the costs which are dependent upon volume.

The above model makes the assumption that costs are a linear function of volume. This is not always the case. For example, production may require fixed assets which have a certain capacity. If production is expanded beyond this minimum capacity, then more fixed assets must be brought on line which involves additional costs. It is therefore possible for the cost function to take many different forms which may include discrete jumps in the function. Costs may also vary with volume in a non-linear way.

Costs may either be defined as the absolute costs incurred or as opportunity costs. The former would include as a cost any benefit that could have been derived for alternative uses of an asset.

There are many well-known techniques for allocating expenses to fixed and marginal costs. Much also has been written about the allocation of costs for the purposes of pricing and investment project evaluation in such texts as “Principles of Corporate Finance” by Brealey and Myers, and “The Strategy and Tactics of Pricing” by Nagle and Holden.

The cost model can be expected to vary in the future. For example, inflation will increase future costs whereas increasing efficiencies and new technology will tend to reduce future costs. It is, therefore, necessary to allow for the Cost Model to be defined for each time period.

For each product category and each time interval, a Demand Model is specified. The Demand Model is a means by which the demand for the product can be calculated for any realistic price for that product. There are many forms the Demand Model can take. In the preferred embodiment, the price elasticity is constant giving the following formula for demand in which D₀ is the demand at price P₀:

Demand=D₀ *(P₀/Price)^{(Price Sensitivity)}

Price Sensitivity may be derived from experience with previous price changes, from market surveys, or from experience from other similar products. There are many techniques for estimating the price sensitivity, and for this purpose it is assumed to be a provided parameter for each product. More generally the Demand Model may be any functional relationship between demand and price. Techniques for establishing demand models and their parameters are well known in the art. Discussion of methods for establishing price sensitivity can be found in texts such as “The Strategy and Tactics of Pricing” by Nagle and Holden.

The Demand Model may change for the future period being considered. For example, if a good is known to fall in price with manufacturing efficiencies then it would be unrealistic to suppose the same Demand Model would hold in the future. As the prices of competitive products reduce, then the demand at any given price will fall. In the preferred embodiment, the Demand Model is specified for each time period.

From the Cost Model and the Demand Model, the optimal price for each product can be calculated. This is the price which maximizes sales revenue minus costs, where sales revenue is price multiplied by volume. For the preferred embodiment, the optimal price is given by the following formula:

Optimal Price=Product Marginal Cost·(1+1/(Price Sensitivity−1))

More generally, given any combinations of Cost Model and Demand Model, the optimal price is determined as the point at which sales revenue minus costs is maximized. This assumes that there is a price at which there is such a maximum. This must always be true of any realistic case; otherwise, the company could earn infinite revenue which is clearly an impossibility. If there is no mathematical maximum, then either the Demand Model or the Cost Model or both have been badly specified. If this happens, then the answer is to respecify the models.

In the general case, the optimal price can be calculated to any desired level of precision by evaluating the Cost and Demand Models at various trial prices. The trial prices start at a price which is definitely below the optimal price and increase by a small increment until a price is reached which is definitely above the optimal price. For each trial price, the demand is evaluated using the Demand Model and the cost is evaluated using the Cost Model based upon the predicted demand. Net revenue is defined by price multiplied by demand less costs. The optimal price is the trial price which generates the greatest revenue. By setting the trial price increment small enough, any desired level of precision can be reached.

As both the Cost and Demand Models may vary in future time periods, determination of optimal price requires recalculation for each time period.

Potential investment opportunities may be received by the present invention from a variety of sources. Typically, more than one “operator” may be involved in producing and evaluating investment opportunities. An advantage of the present invention is that it readily allows professionals from different disciplines to serve as system users or operators. According to the preferred embodiment, the system operates over a computer network or the Internet. This allows common technologies, such as web browsers, to be used as a user or operator console so that investment ideas may come from suppliers, contractors, consultants and other external parties as well as the employees of the organization.

If two or more investments have to be made together to be most effective, then these will be treated by the system as one investment project. It is also possible to define as separate projects various options in implementation of an investment.

For example, suppose that a computer system development can either start this year or next year. This can be defined as two projects: Project “A” involving the computer system implementation being made this year, and Project “B” involving the implementation starting next year. Projects “A” and “B” are made exclusive as the system development cannot both start this year and next year. Defining the options in this way enables different timing options to be tested for the most advantageous combination.

Further according to the preferred embodiment, financial costs and benefits of investments are defined as (i) the change to the Cost Model for each product which the investment affects; and, (ii) any additional fixed costs for the model not captured in the Cost Models. Additional fixed costs can be negative as well as positive. For example, a piece of machinery might be disposed of at the end of the investment period, and a negative cost (equivalent to a credit) would be taken for the projected amount of the disposal proceeds.

Additional fixed costs may also include a negative terminal cost at the end of the projection period where the lifetime of the investment exceeds the projection period.

For example, suppose a financial institution is developing a computer system to service three products A, B and C. The cost of the system is $1M plus a further $0.1 m for each product covered all incurred in the first year. The new system will reduce the unit marginal costs of servicing each product by $10.

Further assume for this example that investments are evaluated on a five year time horizon but the computer system is not expected to need replacement at this time, and on a realistic amortization schedule the company will assign it a value of $0.3 m at the end of five years. Then, the investment will have the following effect on the Cost Models:

(a) increase the product Fixed Costs by $0.1 m for each of products A, B and C in the first year;

(b) reduce the Product Marginal Costs by $10 for each of products A, B and C; and

(c) have an additional fixed cost of $1 m in year one and a negative terminal additional fixed cost of $0.3 m.

This example assumes that the Product Fixed Costs and Product Margin Costs form of the Cost Model is used. In a more general case, the investment may be represented by any change in the Cost Model of the products together with an additional fixed cost.

In addition to the changes to the Cost Model the investment may change the Demand Model for one or more products. Some investments are targeted at increasing demand rather than saving costs. For example, investment in marketing and advertising campaigns are designed to increase sales. To reflect these effects, if an investment affects the Demand Model for one or more products, then for each of those products the change to the Demand Model will be specified. This change in the Demand Model may be specified as either:

(i) the absolute change in units of demand for a given price; or

(ii) a percentage increase or reduction in demand for a given price.

To give an example of the first situation (i), the investment might increase demand by 10,000 units at a price of $10 reducing to 5,000 units at a price of $12. To give an example of the second situation (ii), the investment might increase demand by 10% at a price of $10 increasing to 15% at a price of $12.

There will usually be various constraints upon which combinations of investments can or cannot take place. In the preferred embodiment, these constraints are divided into two types:

(1) “Dependency” wherein an investment project A will be dependent upon an investment project B if A is only possible or will only operate properly if investment B is also made. For example, A might be the development of an in-house software package while B might be the purchase of a new computer system. The software package might require the computer system but not vice versa. If A and B were each dependent upon the other so that the computer system were useless to the organization without the software package then A and B would be most sensibly combined together as a single project; and

(2) “Exclusivity” in which an investment project A will be exclusive of another investment project B if A is only possible or effective if B does not take place or vice versa. This means that no investment combination can involve A and B.

The dependency and exclusivity rules are used to model various relationships between investment projects. For example, suppose that two investments “X” and “Y” both draw heavily upon system development resources so that they could not both be implemented in the same year. This situation could be modeled by defining four investment projects: Project “A” where X is implemented in year 1, Project “B” where is implemented in year 2, Project “C” where Y is implemented in year 1, and Project “D” is Y implemented in year 2. As such, project combinations AB, CD, AC and BD are all by definition exclusive combinations.

As the present invention involves considering combinations of investments, it is necessary to be able to calculate the changes to the cost and demand models of each combination of investments.

The simplest approach (and the preferred embodiment) is to calculate the change in the Cost Model from a combination of investments as the sum of the change in the Cost Model for each investment. For example, if investment A were to involve an increase in fixed costs of 1000 and a reduction in marginal costs of 20 for a particular product, and investment B were to involve an increase in fixed costs of 2000 and a reduction in marginal costs of 30 for the same product, then the cost change from a combination of the two investments would be equal to an increase in fixed costs of 1000+2000=3000 and a reduction in marginal costs of 20+30=50 for the product.

Where an investment involves a change to the demand curve for one or more products, it is also necessary to specify a rule for combining the effects of more than one investment. In the preferred embodiment, the rule used is to start with the base demand model and to add together the change in demand from each investment where the change is specified in absolute units. This demand is then multiplied by the percentage increase or decrease for each investment where the effect on the demand curve is specified in percentage terms.

In other cases, one investment will impact the return expected from another investment in a way which does not fit with the above rules. For example, an investment X might be a training program which increases the productivity of labor on an assembly process by 10%, and hence reduces marginal expenses. A second investment Y might be the purchase of a machine that substitutes for labor. The cost savings from the two investments are not independent of each other. If both investments go ahead together, then the total marginal cost savings will be lower than the sum of the marginal cost savings for each individual investment because the machine substitutes for labor, and the return from the machine investment will depend upon the costs of labor. These costs will be reduced if the training program goes ahead and so the benefits of purchasing the machine will be lower.

This interrelationship can be dealt with by representing the investment projects in the following way. Investment X can be redefined to mean X on its own without Y. Similarly Y can be redefined to mean Y on its own without X. A new investment Z will represent X and Y carried out together. The changes to the cost and demand curves for Z can then be defined separately and can taken into account the interaction of X and Y. Constraints can be set up so that each of X, Y and Z are mutually exclusive of the other two. A similar situation may apply where the investment changes the Demand Model for one or more products.

Net Present Value (NPV) of an investment combination is calculated as the total Net Revenue generated by all products for each time interval within the projection period discounted back to the projection base time. The Net Revenue is calculated as the total revenue less the Total Costs for each period T. The Total Revenue is determined by the sum of price multiplied by demand summed for all products. Total Costs is determined by the sum of the costs generated by the Cost Model for each product plus the direct costs generated by each investment within the combination. Revenue and demand are evaluated at the optimal prices generated by the investment combination.

Many techniques for calculating the Net Present Value (“NPV”) are well known. The NPV can be calculated as the sum of the Net Revenue for each period multiplied by a discount factor for that period. The discount factor will be calculated as:

discount factor=(1+d)^{-t}

where “d” is the discount rate, and “t” is the time from the Projection base time to the time when the cash flow arises which, will usually be taken as mid-way through the relevant time interval.

According to the present invention, an optimization step involves evaluating combinations of investments to achieve the optimal return. For each combination, the NPV is calculated. This NPV is compared to the NPV for the base case. The difference between the NPV's is the Value Added arising from the investment combination. If this Value Added is positive, then the investment combination is viable. The most attractive investment combination is the one with the greatest Value Added provided it is positive.

In the preferred embodiment, the optimization process involves testing all the different combinations of investments. For example, if there are three investment projects, A, B and C then the possible investment combinations are A, B, C, AB, AC, BC and ABC, where AB refers to the combination of A and B, etc.

The combinations of investments considered are preferably limited to those permitted by the constraints. So, for example, if Project A is dependent upon Project B, then any combinations involving A will also have to involve B, and any combinations of Project A exclusive of Project B and vice versa are not considered or analyzed.

One difficulty involving the evaluation of different combinations is that the number of such combinations increases very rapidly with the number of items that can be combined—in this case investment projects. For a relatively small number of investment projects, the problem can be resolved by investigating every combination as in the preferred embodiment. If there are larger numbers of investment projects to be considered, some approximations or simplifications must be made.

One such simplification is by using our Increasing Mutual Returns Rule. This rule states that making an investment will not reduce the returns from other non-exclusive investments. This rule is not guaranteed to be true for all possible specifications of an investment, although it will be true of most realistic cases. One case where it might not be true is if an investment reduces the cost savings or demand increases from other investments. However, such investments will be defined as mutually exclusive options and so the Positive Returns Rule will still apply even in this case.

Applying the Increasing Mutual Returns Rule involves first starting with Maximal Investment Combinations. A Maximal Investment Combination is defined as one which cannot be made larger by adding any investment without breaking constraints. In the simplest case where there are no exclusive constraints, there will be only one Maximal Investment Combination consisting of all investment projects. For example, if there are four investment projects A, B, C and D with no combination constraints, the Maximal Investment Combination will be ABCD. If there are exclusive combination constraints, then the number of possible Maximal Combinations will multiply. For example, if projects C and D are mutually exclusive, then there will be two Maximal investment, namely combinations ABC and ABD, but not ABCD.

To apply the Increasing Mutual Returns Rule, the set of all Maximal Investment Combinations must first be formed using the following general process. Initially, all investment projects which are not exclusive of any other investment projects will form a “core” which will belong to every Maximal Investment Combination. It should be noted that if A is dependent upon B, for example, then A will be exclusive of any project of which B is exclusive.

To this core is added some combination of the investment projects subject to exclusive relationships. The investment projects are formed into groups such that if two investment projects have either a direct or indirect exclusive relationship, then they will be in the same group. If not, they will be in separate groups. By an indirect exclusive relationship it is meant that there is some chain of exclusive relationships between the two investment projects. For example, if project A is exclusive of project B, and project B is exclusive of project C, then projects A and C will have an indirect exclusive relationship, and will be in the same group. It should be noted that this is not the same as assuming that project A and project C will themselves be mutually exclusive. In general, there will be some number N of such groups. For all such groups, all the possible combinations of investment projects within the group will be formed. These combinations which do not meet the constraints will then be eliminated leaving only valid combinations. If any of these valid combinations is a subset of a larger valid combination in the same group, then the smaller combination will be eliminated because it is non-maximal.

The Maximal Investment Combinations will then consist of all possible combinations formed by taking the core combination plus one combination from each of the N groups.

The process proceeds by taking each of these Maximal Investment Combination and testing whether or not each investment adds value, or whether the combination without that investment would have a higher NPV. If eliminating any investment would give a higher NPV, then that investment is eliminated from the combination.

The process is then repeated with the smaller combination until the NPV cannot be increased by eliminating any investment. The Value Added of this combination can then be calculated by taking the NPV and deducting the NPV of the base case. If this Value Added is positive, then the investment combination is a candidate for being an optimal combination. The combination that gives the highest Value Added starting from any Maximal Investment Combination is determined to be the optimal case. Several iterations may be required before an acceptable solution is produced.

The system will produce output showing the return from various combinations of investments. This output can be in the form of a display on a screen or a printout, or in the form of computer files which can be read by a spreadsheet program or other financial application programs, such as a comma separated variable (CSV) file or a tab-delimited data file.

The results output can then be examined by a human operator. In particular, the optimal combination and other combinations near the optimal level can be examined. Following this examination, some of the assumptions may be refined and there may be further iterations of the method.

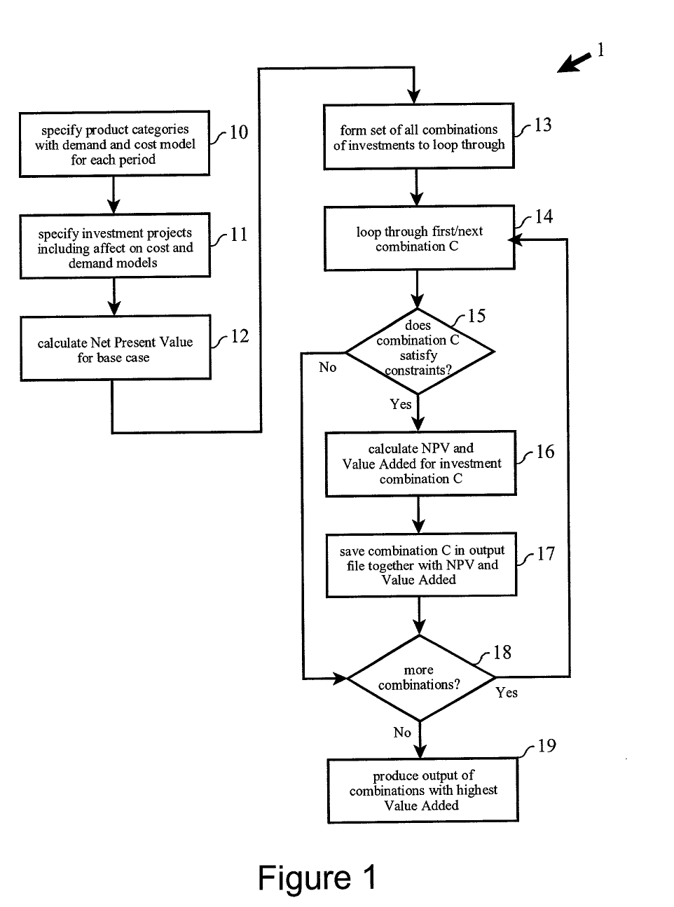

Now, for a more detailed disclosure of the preferred embodiment of the present invention, several diagrams and figures are discussed. Turning to FIG. 1, an overview of the process for the case (1) in which all combinations of possible investments are examined is shown.

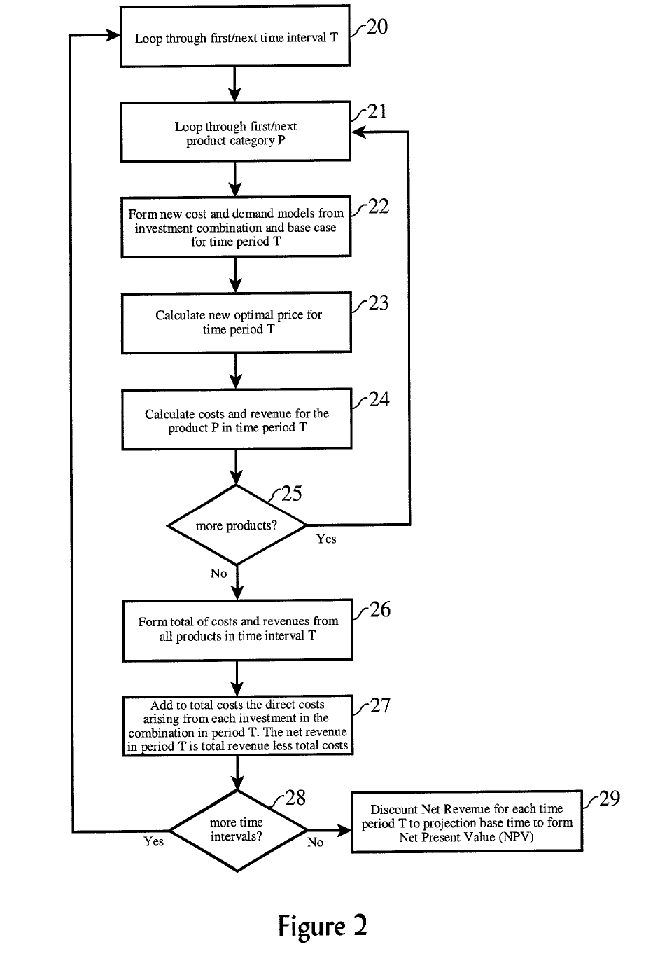

Product categories are specified (10) with associated demand and cost models for each product. The characteristics of potential investment products are specified (11), including the effect of the investment on the cost and demand models of the products it affects. The Net Present Value (“NPV”) is calculated (12) for the “base case” which represents the position if none of the investment projects takes place. More details of the process to determine the NPV is illustrated by FIG. 2, discussed in more detail later.

Continuing with FIG. 1, the program next loops through all possible combinations of investment. The first stage is to form (13) the set of all such combinations. Then, the program loops (14 to 18) through all the combinations starting with the first combination and then taking the next combination each time it goes through the loop.

Each combination is tested (15) to check whether it satisfies all the constraints such as dependency and exclusivity constraints. If the combination fails any constraints, then the program loops forward to test (81) if there are any more combinations to be tested. If the combination satisfies the constraints, then the Net Present Value (“NPV”) is calculated (16).

The Value Added is also calculated (16) and equals the NPV of the combination less the NPV of the base case.

The combination, the NPV and Value Added are saved (17) in a file for later output, preferably. The program then tests (18) whether there are any more combinations to be tested. If so, it loops back to test the next combination (14). If not, it produces (19) an output of the combinations with the highest Value Added. The output may be in the form of a printed output or a display on the computer screen, or a file which could be interrogated by other programs or loaded into a spreadsheet. The output may consist of a list of the most attractive options or a list of all combinations ranked by Value Added. Further in an advanced implementation, a facility to review individual investments and the combinations involving those investments which generate the highest Value Added is provided.

FIG. 2 shows more details of the logical process for calculating NPV for an investment combination C. The process starts by looping (20-28)) through all the time intervals T within the projection period. The loop starts with the first time interval. For each time interval the procedure loops (21-25) through all product categories P, starting with the first product category. The Demand and Cost Models for the product P at time T are formed (22) from the base cost and Demand Models for product P and time T and the modifications specified in the investments which comprise C. In the case of calculating the NPV for the base case, then the investment combination will not consist of any investments and the base cost and demand models are taken.

From the modified Cost and Demand models, the optimal price for product P in time interval T is calculated (23). Using this optimal price and the modified Demand Model, the demand can be calculated. The revenue from the product will equal this demand multiplied by price (24). From this demand and from the modified cost model, the cost can also be calculated (24).

The next step is to test (25) whether there are more product categories. If so, the next product is selected, and the process (21-25) is repeated with this product. If not, the costs and revenues for period T are summed (26) for all the products that have been looped through. To this are added (27) any direct costs arising in period T from any of the investments in the combination C. The Net Revenue for period T is the total revenue for T less the total costs for T (27).

The next step is to test (28) whether there are more time intervals within the projection period. If so, the next time interval is selected and the process (20-28) is repeated. If not, then the Net Present Value is calculated (29) by discounting the Net Revenue for each time period back to the projection base time.

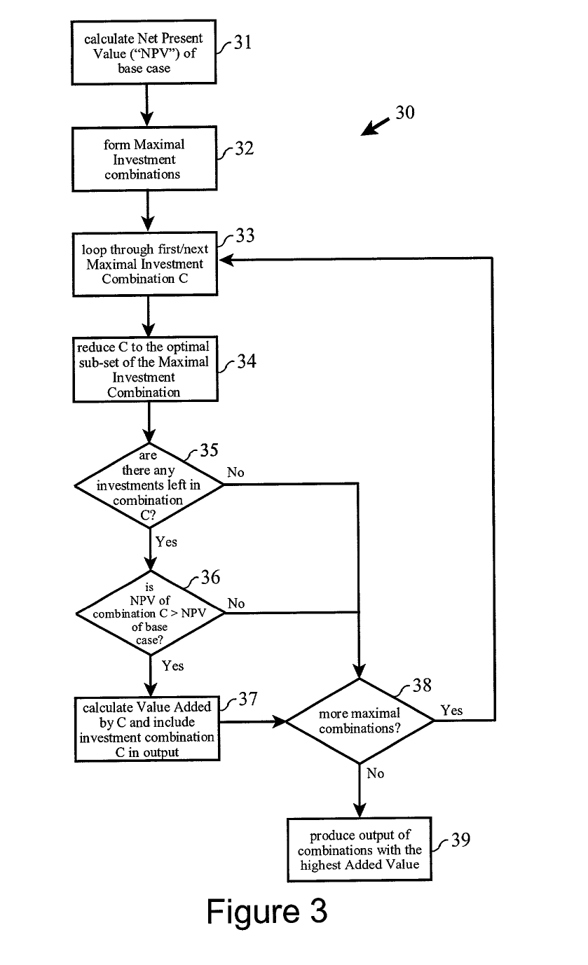

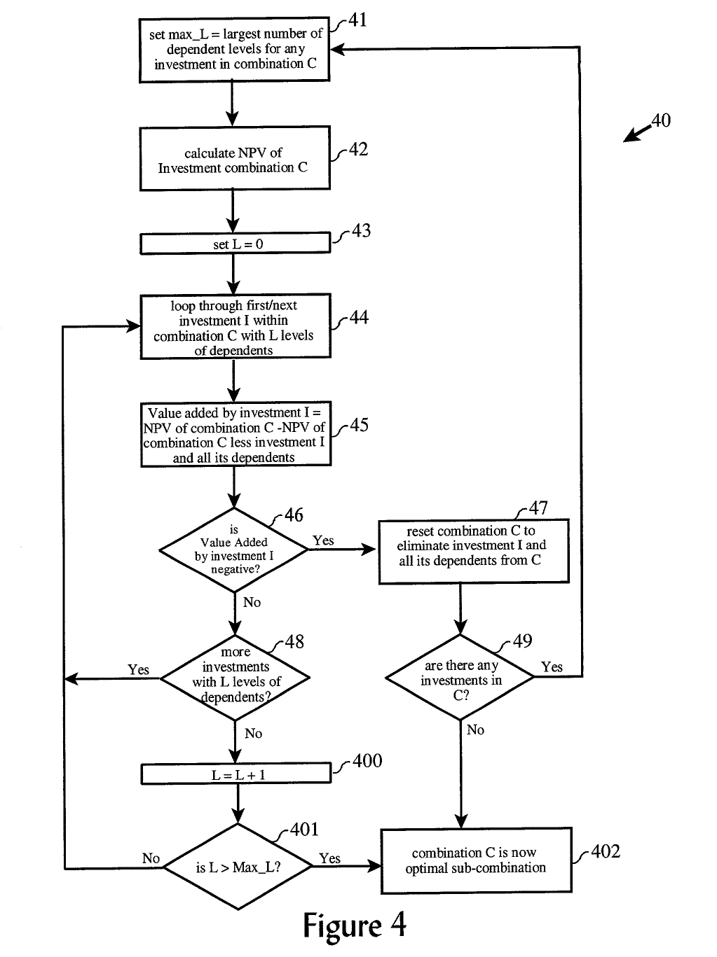

Turning now to FIG. 3, the embodiment (30) involving the Increasing mutual Returns Rule is disclosed in detail. The process starts with the NPV of the base case (31). The next step is to form (32) the Maximal Investment Combinations. The loop (33-38) then begins by taking the first Maximal Investment Combination C. The combination C is then reduced (34) to the optimal sub-combination by the process illustrated in more detail in FIG. 4, discussed later.

The process checks (35) whether there are any more combinations to be tested, and if so loops back to take the next Maximal Investment Combination and repeats the process (33-38).

If all combinations have been checked, then the new combination C is then tested (36) to make sure that it consists of at least one investment and that the NPV is greater than the base case. If so, then the process calculates (37) the Value Added by C as the NPV of C minus the NPV of the base case, and adds C to the output file before checking (38) if there are any more combinations.

Once all Maximal Investment Combinations have been looped through, then the results can be output (39) in the same way as for the preferred embodiment.

FIG. 4 shows the logical process (40) for reducing an investment combination C to the optimal combination. First, a variable “Max_L” is set (41) equal the largest number of dependent levels within C. This depends on the largest chain of dependents that can be formed within C. A dependent chain is where for example A is dependent upon B which is dependent upon C. The number of dependent levels in a chain is equal to the number of successive dependence relationships—in this case would be 2. If there are no dependent relationships within C, then Max_L will be set to zero.

The next steps are to calculate (42) the NPV of C, and to set (43) another variable “L” equal to zero.

The process then loops (44-401) through all the investments I within combination C which have at most L levels of dependents. So, for the initial value of L=0, it takes all those investments which do not have any dependents. For each investment I, the Value Added by the investment is calculated (45) by the NPV of the combination C minus the NPV of the combination C, excluding I and any dependents of I.

If for any investment the Value Added is negative (46), then that investment and all its dependents are eliminated (47) from C. If C still contains at least one investment project (49), the process is restarted (41) with the smaller combination C and a new value of Max_L is calculated.

If all investments have non-negative Value Added (46), then L is increased by 1 (400) and tested (401) to check if it exceeds Max_L. If it does, then the combination C is now the optimal sub-combination (402). If it does not exceed Max_L, then there are still more investments to check, so the process loops back to consider (44) all those investments with at most the new L level of dependents.

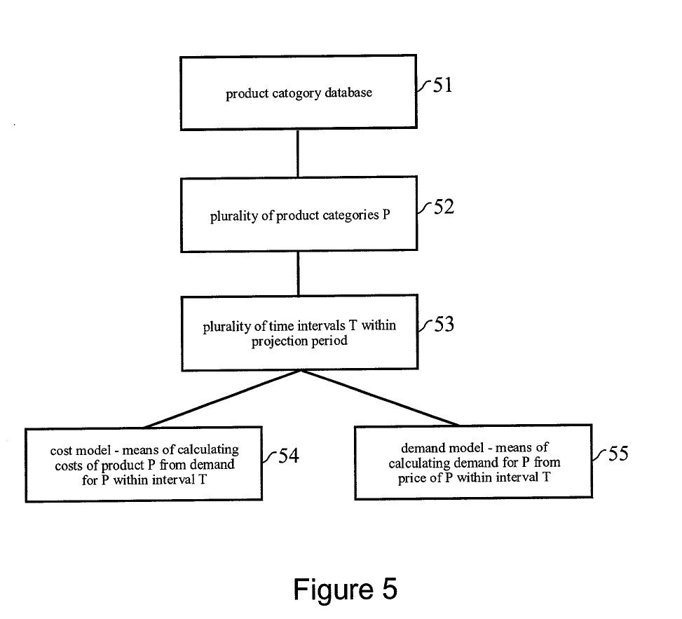

FIG. 5 shows the structure of the product category database (51) according to the preferred embodiment. The database (51) consists of a number of product categories (52). For each product category P, there may be a number of time intervals (53) within the projection period. For each time interval T and each product category P, a Cost Model (54) and a Demand Model (55) will be specified. These give rise to the base case for that product and time interval.

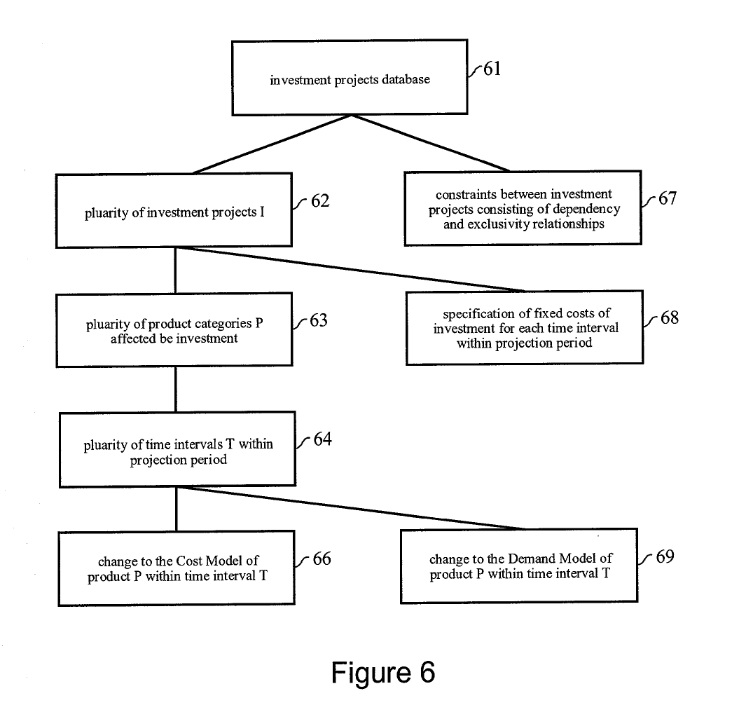

FIG. 6 shows the structure of the investment projects database (61) according to the preferred embodiment. The projects database (61) consists of a number of investment projects (62), and it may also contain various constraints (67) such as dependency and exclusivity relationships defined between these investment projects.

Each investment project I has a number of product categories (63) which are affected by the investment, as well as associated fixed costs (68) for the investment for each time interval within the period. These costs may include a start value and an end value. Costs in this context can be either positive or negative.

For each of the product categories P affected by project I, the number of time intervals (64) within the projection period are specified. Within each of these time intervals T, there are defined a means for modifying (66) the Cost Model and a means for modifying (69) the Demand Model of product P in time interval T. Either of these means might be defined as “null”, meaning that it does not change the appropriate model for product P in interval T.

While disclosure of a generalized process and system have been given as well as specific details of a preferred embodiment, it will be recognized by those skilled in the art that certain variations, substitutions, or alternations may be made without departing from the spirit and scope of the invention, including but not limited to use of alternate programming languages and methodologies, alternate computing platforms, and equivalent data structures and logical processes. Therefore, the scope of the present invention should be determined by the following claims.

What is claimed is:

1. A method for determining a likely return on investment from combinations of investment projects and selecting a combination having a maximum return on investment, said investment projects being related to product categories, each product category having a given cost model and demand model, said method comprising the steps of:
forming a plurality of candidate investment project combinations including all possible projects in all possible combinations;
eliminating from further consideration project combinations which do not meet conditions of a set of constraints;
determining a new optimal price and changes to the cost and demand models associated with each product category for each of the project combinations;
estimating a value added by each project combination for each set of project combinations using the new optimal prices and the changes to the costs and demand models;
identifying the project combination which yields maximum value added; and
providing an output containing said estimated values added and identified project combination.

2. The method as set forth in claim 1 wherein said step of elimination comprises eliminating investment combinations which include projects which are mutually exclusive.

3. The method as set forth in claim 1 wherein said step of elimination comprises eliminating investment combinations which include projects which are dependent on other projects which are excluded from the combination.

4. The method as set forth in claim 1 wherein said step of identifying a project combination which yields maximum value added comprises:
determining Net Present Value for a base case in the scenario that none of the project combinations are undertaken, and a Net Present Value for each project combination;
assigning a Value Added for each project combination by subtracting said base case Net Present Value from each respective project combination Net Present Value.

5. The method as set forth in claim 1 wherein said step of providing an output comprises providing a computer readable output.

6. The method as set forth in claim 1 wherein said step of providing an output comprises providing a human readable output.

7. The method as set forth in claim 1 further comprising the steps of:
forming a set of all Maximal Investment Combinations; and
applying an Increasing Mutual Returns Rule to said set of all Maximal Investment Combinations in order to further reduce a total number of project combinations for analysis.

8. A computer readable medium encoded with software for determining a likely return on investment from combinations of investment projects and selecting a combination having a maximum return on investment, said investment projects being related to product categories, each product category having a given cost model and demand model, said software causing a computer to perform the steps of:
forming a plurality of candidate investment project combinations including all possible projects in all possible combinations;
eliminating from further consideration project combinations which do not meet conditions of a set of constraints;
determining a new optimal price and changes to the cost and demand models associated with each product category for each of the project combinations;
estimating a value added by each project combination for each set of project combinations using the new optimal prices and the changes to the costs and demand models;
identifying the project combination which yields maximum value added; and
providing an output containing said estimated values added and identified project combination.

9. The computer readable medium as set forth in claim 7 wherein said software for candidate project combination elimination according to constraints comprises software for eliminating investment combinations which include projects which are mutually exclusive.

10. The computer readable medium as set forth in claim 7 wherein said software for candidate project combination elimination according to constraints comprises software for eliminating project combinations which include projects that are dependent on other projects which are excluded from the combination.

11. The computer readable medium as set forth in claim 7 wherein said software for identifying a project combination which yields maximum value added comprises software for performing the steps of:
determining Net Present Value for a base case in the scenario that none of the project combinations are undertaken, and a Net Present Value for each project combination;
assigning a Value Added for each project combination by subtracting said base case Net Present Value from each respective project combination Net Present Value.

12. The computer readable medium as set forth in claim 7 wherein said software for providing an output comprises software for providing a computer readable output.

13. The computer readable medium as set forth in claim 7 wherein said software for providing an output comprises software for providing a human readable output.

14. The computer readable medium as set forth in claim 7 wherein said software further comprises software for performing the steps of:
forming a set of all Maximal Investment Combinations; and
applying an Increasing Mutual Returns Rule to said set of all Maximal Investment Combinations in order to further reduce a total number of project combinations for analysis.

15. A system for determining a likely return on investment from combinations of investment projects and selecting a combination having a maximum return on investment, said system comprising:
a product category data store having a plurality of product categories, and having a plurality of cost models and demand models for a plurality of time intervals for each said product category;
a investment projects data store containing a plurality of investment project data sets, each data set containing dependency and exclusivity relationships, definitions of product categories affected by a project, fixed costs for a plurality of time intervals, and a means for modification of cost models and demand models; and
a parallel investment evaluator adapted to access said investment projects data store and product category data store, to determine a combination of investment projects which yield a maximum value added, and to output said project combination and maximum value added.

16. The system as set forth in claim 15 wherein said parallel investment evaluator is adapted to perform the steps of:
forming a plurality of candidate investment project combinations including all possible projects in all possible combinations;
eliminating from further consideration project combinations which do not meet conditions of a set of constraints;
determining a new optimal price and changes to the cost and demand models associated with each product category for each of the project combinations;
estimating a value added by each project combination for each set of project combinations using the new optimal prices and the changes to the costs and demand models;
identifying the project combination which yields maximum value added; and providing an output containing said estimated values added and identified project combination.

17. The system as set forth in claim 16 wherein said parallel investment evaluator is further adapted to perform the steps of:
determining a Net Present Value for a base case in the scenario that none of the project combinations are undertaken, and a Net Present Value for each project combination;
assigning a Value Added for each project combination by subtracting said base case Net Present Value from each respective project combination Net Present Value.

18. The system as set forth in claim 16 wherein said parallel investment evaluator is further adapted to perform the steps of:
forming a set of all Maximal Investment Combinations; and
applying an Increasing Mutual Returns Rule to said set of all Maximal Investment Combinations in order to further reduce a total number of project combinations for analysis.
